(19) United States
(12) Patent Application Publication
(10) Pub. No.: US 2026/0151900 A1
(43) Pub. Date: Jun. 4, 2026

(54) GRIP FORCE ESTIMATION DEVICE, GRIP FORCE ESTIMATION METHOD, AND GRIP FORCE ESTIMATION PROGRAM

(71) Applicant: SONY GROUP CORPORATION, TOKYO (JP)

(72) Inventors: SHUNICHI SEKIGUCHI, TOKYO (JP); HIROTAKA SUZUKI, TOKYO (JP); TAKAYOSHI TAKAYANAGI, TOKYO (JP); KEN KOBAYASHI, TOKYO (JP); TAKEHIRO MISONOU, TOKYO (JP); AKIHIRO NOMOTO, TOKYO (JP); TETSURO GOTO

(21) Appl. No.: 18/702,091

(22) PCT Filed: Sep. 22, 2022
(86) PCT No.: PCT/JP2022/035386

§ 371 Date: Apr. 17, 2024

(30) Foreign Application Priority Data
Oct. 27, 2021 (JP) 2021-175566

(51) Int. Cl. B25J 9/16; B25J 13/00; G06V 10/774; G06V 20/50; G06V 40/13; G06V 40/20

(52) U.S. Cl. CPC B25J 9/1612; B25J 13/003; G06V 10/774; G06V 20/50; G06V 40/13; G06V 40/20

(57) ABSTRACT

A grip force estimation device (100) according to the present disclosure includes: an acquisition unit (131) that acquires a grip force at a time when a person grips an object and a trace of gripping by the person, the trace left on the object at the time of the gripping; and a generation unit (132) that generates a model that outputs a grip force at a time when a predetermined object is gripped in a case where an image is input, the image including a trace at a time when the predetermined object has been gripped by a person, on the basis of learning data obtained by combining the grip force and the trace acquired by the acquisition unit.

### FIELD

The present disclosure relates to a grip force estimation device, a grip force estimation method, and a grip force estimation program. More specifically, the present disclosure relates to information processing for estimating an appropriate grip force when a robot arm grips an object.

### BACKGROUND

Mechanical devices (hereinafter, collectively referred to as “robots”) such as robot arms are introduced in various technical fields and play important roles in production processes. Conceivable as one of important matters in the control regarding robots is processing of determining an appropriate grip force at the time when a robot grips an object.

As an example, there is proposed a grip force control device that receives input of a motor drive current and a motor rotation speed, estimates grip force of a gripping device, and performs driving while controlling so as to eliminate a deviation between the grip force estimation value and a grip force target value (for example, Patent Literature 1). There is also known technique for obtaining tactile information such as how much force should be used to grip an object from visual information of the object using machine learning (for example, Patent Literature 2).

### CITATION LIST

### Patent Literatures

Patent Literature 1: JP 2002-178281 A

Patent Literature 2: JP 2020-73871 A

### SUMMARY

### Technical Problem

In a case where a robot is caused to grip various objects, it is desirable to employ a method in which the robot autonomously learns the relationship between the object and the appropriate grip force in order to save time and labor for a person to investigate the appropriate grip force for various objects by repeating trials. For example, a robot arm is attached with a tactile sensor at the tip of a gripper thereof and is caused to grip various objects to learn a relationship between the object and the appropriate grip force using, as a reward, whether the various objects could be gripped without being broken (or without being dropped). In this method, once an autonomous learning system is constructed successfully, gripping with an appropriate grip force can be implemented without human intervention thereafter.

However, since the tactile sensor is fragile, there is a risk of a change in the measurement value or malfunction due to repeated trials for learning. In addition, since the tactile sensor is relatively expensive, it is desirable to reduce the frequency of use as much as possible. A method of attaching a tactile sensor to a hand or finger of a person and teaching the grip force measured in this manner to a robot arm is also conceivable. However, it takes time and labor to attach the tactile sensor, and a hand or finger to which the tactile sensor is attached have a difference sense from a normal hand and finger, and thus the person may not be able to grip with an appropriate grip force.

Therefore, the present disclosure proposes a grip force estimation device, a grip force estimation method, and a grip force estimation program capable of reducing the use frequency of a tactile sensor and teaching a robot the grip force having been measured without changing the sense of a human hand and fingers.

### Solution to Problem

In order to solve the above problems, a grip force estimation device according to the present disclosure includes an acquisition unit that acquires a grip force at a time when a person grips an object and a trace of gripping by the person, the trace left on the object at the time of the gripping, and a generation unit that generates a model that outputs a grip force at a time when a predetermined object is gripped in a case where an image is input, the image including a trace at a time when the predetermined object has been gripped by a person, on the basis of learning data obtained by combining the grip force and the trace acquired by the acquisition unit.

### BRIEF DESCRIPTION OF DRAWINGS

FIG. 1 is a flowchart illustrating a flow of gripping processing of a robot to which the technology of the present disclosure can be applied.

FIG. 2 is a diagram illustrating a configuration example of a grip force estimation system according to an embodiment.

FIG. 3 is a flowchart illustrating a flow of acquisition processing of a learning data set according to an embodiment.

FIG. 4A is a diagram for explaining the learning data set according to the embodiment.

FIG. 4B is a diagram for explaining a model according to the embodiment.

FIG. 5 is a flowchart illustrating a flow of learning processing of a model according to the embodiment.

FIG. 6 is a flowchart illustrating a flow of teaching processing according to the embodiment.

FIG. 7 is a diagram for explaining teaching data according to the embodiment.

FIG. 8 is a flowchart illustrating a flow of grip force determining processing according to the embodiment.

FIG. 9 is a diagram illustrating a configuration example of an information processing device according to the embodiment.

FIG. 10 is a table illustrating an example of a learning data storage unit according to the embodiment of the disclosure.

FIG. 11 is a table illustrating an example of a teaching data storage unit according to the embodiment of the disclosure.

FIG. 12 is a diagram illustrating a configuration example of a model for executing fingerprint complementing processing.

FIG. 13 is a flowchart illustrating a flow of learning processing of a complementer regarding a fingerprint.

FIG. 14 is a diagram illustrating a configuration example of a model for executing extraction processing of surface characteristics of an object.

FIG. 15A is a diagram for explaining an extended learning data set for performing learning of a surface characteristic extractor.

FIG. 15B is a diagram for describing a preliminary learning data set.

FIG. 16 is a flowchart illustrating a flow of learning processing of the surface characteristic extractor.

FIG. 17 is a flowchart illustrating a flow of teaching processing in consideration of a linguistic instruction.

FIG. 18 is a hardware configuration diagram illustrating an example of a computer that implements functions of the information processing device.

### DESCRIPTION OF EMBODIMENTS

Hereinafter, embodiments will be described in detail on the basis of the drawings. Note that in each of the following embodiments, the same parts are denoted by the same symbols, and redundant description will be omitted.

The present disclosure will be described in the following order of items.
1. Embodiment
1-1. Application Example of Technology According to Present Disclosure
1-2. Configuration of Grip Force Estimation System According to Embodiment
1-3. Details of Grip Force Estimation Processing According to Embodiment
1-4. Configuration of Information Processing Device According to Embodiment
1-5. Application Examples of Embodiment
1-5-1. Fingerprint Complementing Processing
1-5-2. Processing in Consideration of Surface Characteristics of Object
1-5-3. Processing in Consideration of Unique Expression by User
1-6. Modification of Embodiment
2. Other Embodiments
3. Effects of Grip Force Estimation Device According to Present Disclosure
4. Hardware Configuration

### 1. Embodiments

### 1-1. Application Example of Technology According to Present Disclosure

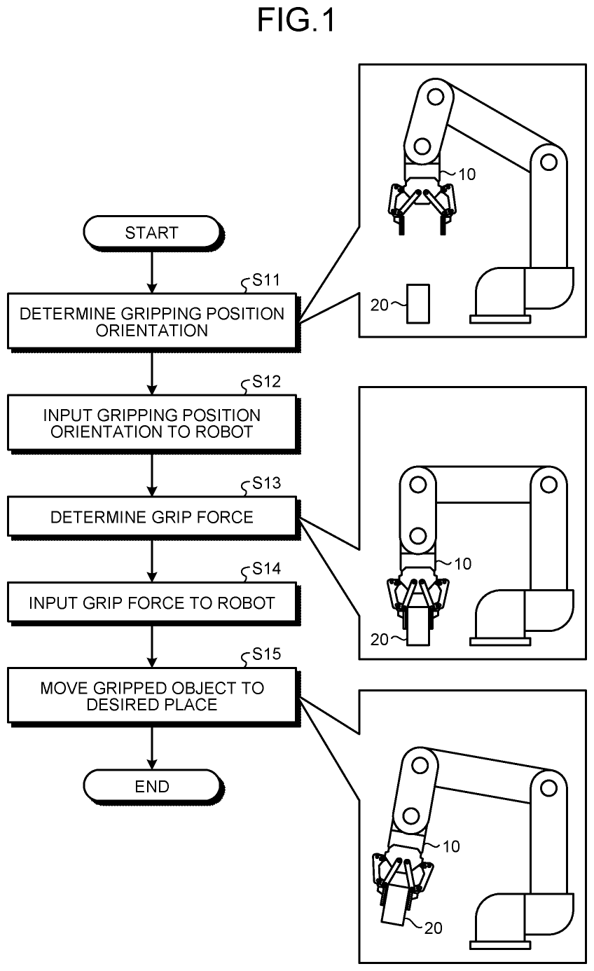

FIG. 1 is a flowchart illustrating a flow of gripping processing of a robot 10 to which the technology of the present disclosure can be applied. In the example illustrated in FIG. 1, the robot 10 has a so-called parallel two-finger gripper having two gripping portions. The robot 10 grips an object 20 with the gripper, lifts the object 20, and moves the object 20 to a desired place. The flow of such processing will be described with reference to FIG. 1.

First, an administrator or the like (hereinafter, referred to as a “user”) who uses the robot 10 determines a gripping position orientation for the robot 10 to grip the object 20 (Step S11). The user inputs the determined gripping position orientation to the robot 10 (Step S12). As illustrated in FIG. 1, the robot 10 brings the gripper closer to the object 20 after adjusting to a position and orientation in which the object 20 can be gripped.

Subsequently, the user determines grip force with which the robot 10 grips the object 20 (Step S13). The user inputs the determined grip force to the robot 10 (Step S14). As illustrated in FIG. 1, the robot 10 can grip the object 20 without damaging the object 20 by gripping the object 20 with the grip force input by the user.

Then, the robot 10 moves the gripped object 20 to a desired place in accordance with the user's instruction (Step S15). A robot 10 to which the technology of the present disclosure can be applied performs gripping processing as illustrated in FIG. 1.

Incidentally, in general, in a case where a robot arm grips a soft object or a fragile object, with how much grip force the gripper is closed is measured using a tactile sensor attached to the tip of the gripper, and this value is fed back, whereby the gripping is implemented with an appropriate grip force without breaking the object. In this case, the user is required to determine appropriate grip force depending on each gripping target object. That is, if the robot arm always grips with grip force of the maximum output, the shape may be deformed or the object may be broken depending on the gripping target object. On the other hand, in a case where the robot arm grips an object with grip force lower than an appropriate value, this causes the gripping target object to be not completely gripped and to be dropped.

The simplest method for achieving gripping with appropriate grip force is to cause the robot arm to grip a target object with various grip forces and to determine an appropriate value by trial and error. However, this method requires enormous time and labor. Moreover, each time a new object is given, the user needs to repeat this trial and error, and thus generalizability is also low. Conceivable as a method for reducing the enormous time and labor is a method in which the robot arm autonomously learns the relationship between the object and the appropriate grip force. That is, a robot arm to which a tactile sensor is attached at the tip of a gripper is used and is caused to grip various fragile objects by trial and error to autonomously learn a relationship between the object and the appropriate grip force using, as a reward, whether the various objects could be gripped without being broken (or without being dropped). In this method, once an autonomous learning system is constructed and operated, gripping with an appropriate grip force can be implemented without intervention of the user.

However, in the above method, it is necessary to repeatedly use the gripper to which the tactile sensor is attached when the grip force is determined. In general, a tactile sensor is fragile, and thus it is desirable to reduce the use frequency of the tactile sensor as much as possible to implement gripping with an appropriate grip force when the grip force is determined. Therefore, a method is conceivable in which a tactile sensor is attached to a hand or finger of a person, the person grips an object, and the grip force is used, namely, a method of using teaching by a person. In this method, since the person grips the object, it is not necessary to estimate the grip force by trial and error, and thus the possibility of breaking the tactile sensor is low. However, it takes time and labor to attach a tactile sensor to a hand or finger of a person, and the hand or the finger to which the tactile sensor is attached have a difference sense from a normal hand and finger, and thus the person may not be able to grip the object with an appropriate grip force.

In view of the above circumstances, there is a demand for a method for reducing the labor of attaching a device such as a tactile sensor and implementing teaching of the grip force that is unlikely to disturb the sense of a hand and fingers of a person. Therefore, the technology according to the present disclosure solves the above problem by processing described below. That is, the technology according to the present disclosure acquires a grip force at a time when a person grips an object and a trace of gripping by the person, the trace left to the object at the time of the gripping and generates a model that outputs a grip force at a time when a predetermined object is gripped in a case where an image is input, the image including a trace at a time when the predetermined object has been gripped by a person, on a basis of learning data obtained by combining the grip force and the trace that have been acquired.

For example, the technology according to the present disclosure generates a grip force estimator that has learned a relationship between the grip force and ink traces, the grip force with which objects have been gripped by fingers of a person applied with ink. When teaching the grip force to the robot 10 by a person, the person applies ink to a finger and grips an object, and with how much grip force the person has gripped the object is estimated from an image of the ink trace on the object. Since it is not necessary to attach a device such as a tactile sensor by using the ink in this manner, it is possible to greatly save time and labor for teaching, and the sense of the hand and fingers is less likely to be different from that of a usual hand and fingers due to the attached device. When the relationship between the image of the ink trace and the grip force is learned, a person applies ink to the finger, grips an object to which the tactile sensor is attached with various grip forces, whereby a learning data set is created. Once an estimator capable of estimating the grip force from an image of an ink trace is learned, in subsequent grip force estimation processing, it is only required that a person apply ink and perform teaching without attaching a device or the like, and an appropriate grip force can be calculated at a higher speed than the above-described method of estimating the grip force by trial and error.

The technology according to the present disclosure is used to determine the grip force when the robot 10 grips the object 20 in the example as illustrated in FIG. 1. For example, in a case where the robot 10 is a domestic robot, the user can use the technology of the present disclosure in teaching the grip force to the domestic robot. That is, since it is quite difficult to program in advance how much grip force should be applied to grip for all various objects at home, it is highly necessary for the user to teach the robot the grip force.

However, it is difficult for a user, who is not an expert, to handle a fragile tactile sensor. The technology of the present disclosure includes a simple process in which the user applies ink and grips an object and a trace of the ink is photographed, thereby enabling the user to easily implement teaching of the grip force.

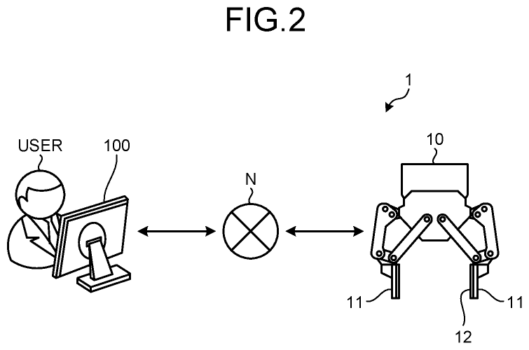

An example to which the technology according to the present disclosure can be applied has been described above. Next, the technology according to the present disclosure will be described in detail with reference to FIG. 2 and subsequent drawings.

### 1-2. Configuration of Grip Force Estimation System According to Embodiment

FIG. 2 is a diagram illustrating a configuration example of a grip force estimation system 1 according to an embodiment.

Information processing according to the embodiment of the disclosure is implemented by the grip force estimation system 1 illustrated in FIG. 2.

As illustrated in FIG. 2, the grip force estimation system 1 includes an information processing device 100 and a robot 10. The information processing device 100 and the robot 10 are connected with a network N (the Internet, near field communication, or the like) in a wired or wireless manner and transmit and receive information via the network N.

The information processing device 100 is an example of the grip force estimation device according to the present disclosure and executes information processing according to the disclosure. For example, the information processing device 100 generates a learned model (hereinafter, simply referred to as a “model”) in which the relationship between the ink trace and the grip force has been learned and estimates the grip force at the time when the robot 10 grips a target object using the generated model. The information processing device 100 is, for example, a computer, a server, a tablet terminal, or the like capable of accepting input from a user.

The robot 10 is an example of a mechanical device that performs predetermined processing in cooperation with the information processing device 100. In the embodiment, as the predetermined processing, the robot 10 performs processing of gripping an object and moving the gripped object to a predetermined position. In the embodiment, the robot 10 includes two gripping portions 11 for gripping an object. Incidentally, the robot 10 includes a tactile sensor 12 on the inner side of a gripping portion 11 (the side on which an object is gripped) as necessary. Note that, although not illustrated in FIG. 2, the robot 10 may include various general sensors (sensors capable of object detection, image recognition, distance measurement to an object, measurement of balance, acceleration, and others) used to grip an object.

### 1-3. Details of Grip Force Estimation Processing According to Embodiment

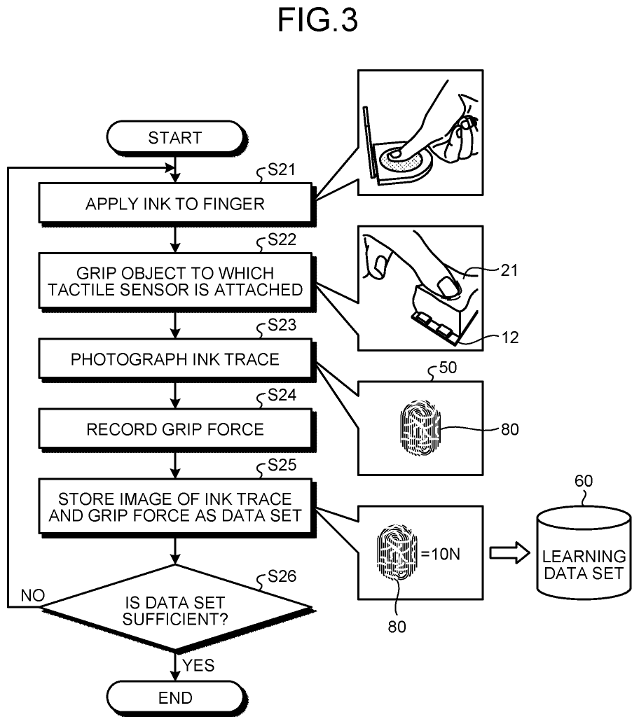

Next, details of grip force estimation processing according to the embodiment will be described with reference to FIG. 3 and subsequent drawings. FIG. 3 is a flowchart illustrating a flow of acquisition processing of a learning data set according to the embodiment.

First, the user applies ink to a finger that grips an object (Step S21). Subsequently, the user grips an object 21 to which a tactile sensor 12 is attached (Step S22). Note that the tactile sensor 12 is attached to a back side of the object 21, namely, the side with which the user's fingers do not come into direct contact.

After a finger trace by the ink, namely, a trace on the object 21, is left, the user photographs this ink trace 80 (Step S23). That is, the information processing device 100 acquires an image 50 including the ink trace 80. The information processing device 100 records the grip force observed when the ink trace 80 has been left (Step S24).

Then, the information processing device 100 sets the image 50 including the ink trace 80 and the grip force (10 newtons (N) ) in the example of FIG. 3) as a data set and stores the data set as a learning data set 60 (Step S25). That is, the learning data in FIG. 3 is data in which the grip force when the user has ripped the object 21 and the ink trace 80, which is a mark due to the user's gripping and left on the object 21 at the time of gripping, are combined.

Then, the information processing device 100 determines whether or not data sets used for learning is sufficient (Step S26). The criterion of whether the data sets are sufficient may be determined by the user as desired depending on the type of a model to be learned, the accuracy of the grip force estimation required by the user, or the like. If the data sets are not sufficient (Step S26; No), the user changes the object 21 to another object and repeats the flow from Step S21 to Step S25 a desired number of times.

If the data sets are sufficient (Step S26; Yes), the information processing device 100 ends the acquisition processing of the learning data set.

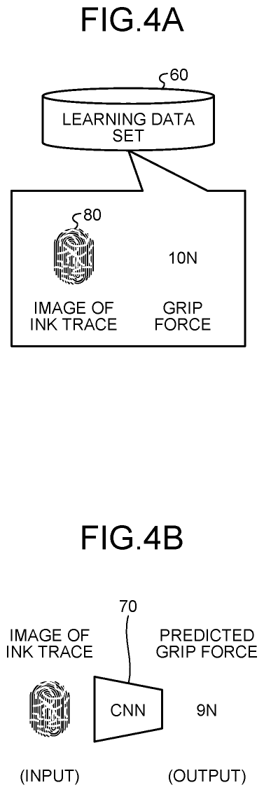

The learning data set and the model according to the embodiment will be described with reference to FIGS. 4A and 4B. FIG. 4A is a diagram for explaining the learning data set according to the embodiment.

As illustrated in FIG. 4A, the learning data set stored as the learning data set 60 includes the image including the ink trace 80 when the object has been gripped and the grip force observed upon the gripping.

FIG. 4B is a diagram for explaining the model according to the embodiment. As illustrated in FIG. 4B, a model 70 according to the embodiment receives an image of an ink trace as input and outputs a predicted grip force corresponding to the image. The model 70 has, for example, a configuration as a convolutional neural network (CNN). Note that the model 70 is not limited to the CNN and may have any configuration as long as a grip force corresponding to an image can be output when the image is used as input.

In general, it is inferred that a trace left when the user grips an object with a relatively large grip force and a trace left when the user grips the object with a relatively small grip force have different shades of ink, sharpness of the fingerprint, and others. The model 70 regards such a difference in traces as a feature amount and learns the relationship with the grip force at the time when the trace has been obtained. As a result, in a case where a certain trace is input, the learned model 70 can output a predicted grip force at the time when the trace has been obtained. That is, according to the model 70, the user can recognize the grip force at the time when the object has been gripped without using the tactile sensor 12.

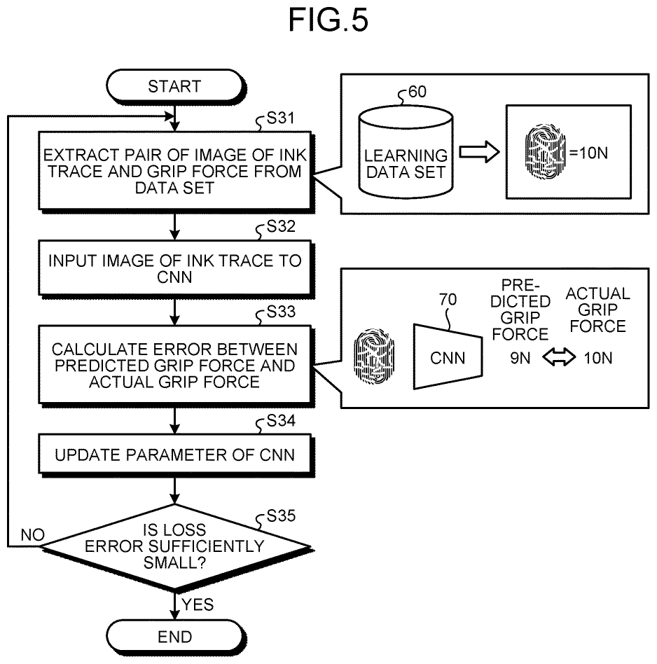

Next, a flow of learning processing of the model 70 (estimator) according to the embodiment will be described with reference to FIG. 5. FIG. 5 is a flowchart illustrating the flow of the learning processing of the model 70 according to the embodiment.

The information processing device 100 extracts the pair of the image of the ink trace and the grip force from the learning data set 60 acquired in the processing of FIG. 3 (Step S31). Subsequently, the information processing device 100 inputs an image of an ink trace to the CNN included in the model 70 (Step S32).

The information processing device 100 calculates an error between the grip force predicted by the model 70 (grip force output from the model 70) and the actual grip force (Step S33). In the example of FIG. 5, the model 70 outputs the predicted grip force as “9 N”; however, the actual grip force actually associated with the ink trace is “10 N”. The information processing device 100 updates a parameter of the CNN so as to minimize such an error (Step S34).

The information processing device 100 determines whether or not a loss error is sufficiently small (Step S35). The criterion as to whether or not the loss error is sufficiently small may be determined as desired by the user by applying the criterion to an accuracy of the model 70 desired by the user, a desired evaluation criterion of the CNN, or the like. If the information processing device 100 determines that the loss error is not yet sufficiently small (Step S35; No), the processing from Step S31 to Step S34 is repeated, and the learning is continued. On the other hand, if it is determined that the loss error is sufficiently small (Step S35; Yes), the information processing device 100 completes generation of the model 70 capable of grip force estimation and acquires the model 70.

Note that the flow of the learning processing illustrated in FIG. 5 is an example, and the information processing device 100 may adopt another method as long as it is a method used for learning of a neural network (NN) and can learn in accordance with the purpose of the model 70.

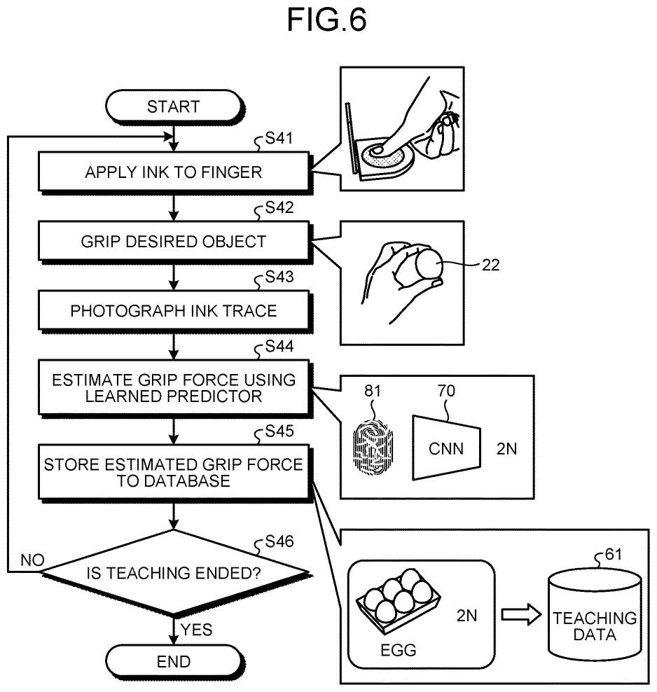

With the processing up to FIG. 5, the information processing device 100 generates the model 70 that is a model for estimating a grip force for an object. In FIG. 6 and subsequent drawings, description will be given on processing for the information processing device 100 to estimate a grip force for an unknown object using the model 70 and to generate teaching data.

For example, in order to teach the robot 10 the grip force of an unknown object, the user performs the processing illustrated in FIG. 6 and subsequent drawings. In a teaching step, the user prepares an object and ink for teaching the grip force to the robot 10. On the other hand, unlike in the learning step, the tactile sensor 12 is not necessary in the teaching step.

The overview of the teaching step is that the user applies ink to fingers, grips an object for which the grip force is desired to be taught, and stores the grip force estimated from the finger trace and object information in a database. The user can create a database in which the object information and the grip force are associated with each other without using the tactile sensor 12 by repeating this flow by the number of objects desired to be taught about. Such processing will be described along the flow with reference to FIG. 6. FIG. 6 is a flowchart illustrating a flow of teaching processing according to the embodiment.

As illustrated in FIG. 6, the user applies ink to a finger used for gripping (Step S41). Then, the user grips a desired object 22 as a gripping target (Step S42).

Subsequently, the user photographs an ink trace 81 left on the object 22 (Step S43). As a result, the information processing device 100 acquires an image including the ink trace 81.

The information processing device 100 estimates the grip force for the object 22 using the learned predictor (namely, the model 70) (Step S44). That is, the information processing device 100 inputs the image including the ink trace 81 to the model 70 and outputs a predicted grip force corresponding to the ink trace 81. In the example of FIG. 6, it is based on the premise that the information processing device 100 estimates the grip force at the time when the user has gripped the object 22 to be “2 N”.

Subsequently, the information processing device 100 combines the estimated grip force and identification information for identifying the gripped object 22 and holds the combined data in the database that holds teaching data for the robot 10 (teaching data 61 in the example of FIG. 6) (Step S45).

Then, the information processing device 100 determines whether or not to end collecting the teaching data (Step S46). If collection of teaching data is continued (Step S46; No), the information processing device 100 repeats the processing from Step S41 to Step S45 and continues to collect teaching data of various objects. On the other hand, if it is determined that the user has finished collecting a necessary number of pieces of teaching data, the information processing device 100 ends collecting the teaching data (Step S46; Yes).

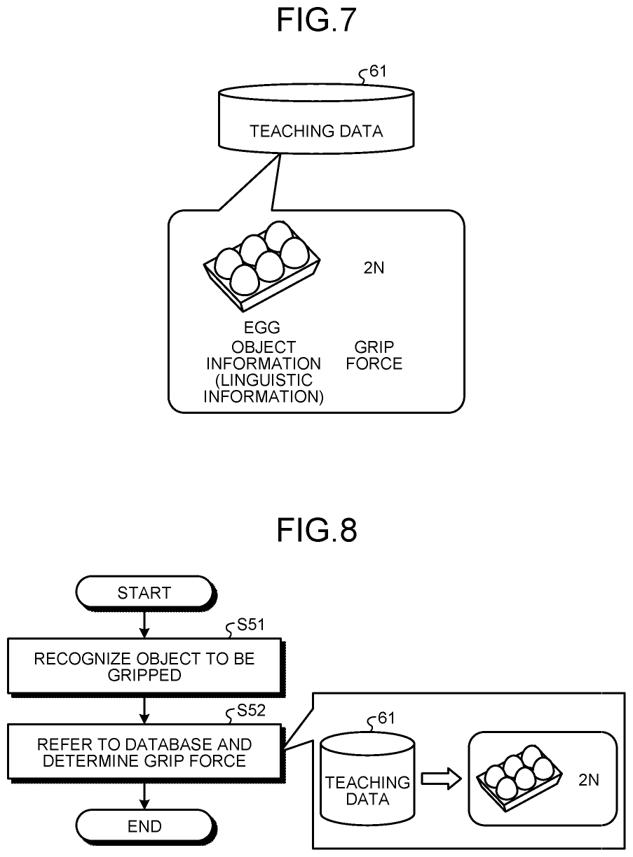

Next, the teaching data according to the embodiment will be described with reference to FIG. 7. FIG. 7 is a diagram for explaining the teaching data according to the embodiment.

As illustrated in FIG. 7, the teaching data 61 is a combination of the grip force at the time when the user has gripped the object (namely, the grip force estimated by the model 70) and the identification information for identifying the object gripped by the user. The identification information for identifying the object is, for example, linguistic information such as the name of the object. In the example of FIG. 7, linguistic information (label) “egg” is given to the object. Note that the identification information may be any information as long as the information identifies the object and may be, for example, an image capturing the object.

Next, processing of teaching the grip force to the robot 10 by the user will be described with reference to FIG. 8. FIG. 8 is a flowchart illustrating a flow of grip force determining processing according to the embodiment.

The information processing device 100 recognizes an object to be gripped by the robot 10 (Step S51). Note that recognition of the object may be implemented by any method such as image recognition processing of a result of imaging of the object by the information processing device 100 or the robot 10 using a camera or the like or the user inputting object information (for example, a name such as “egg”).

Subsequently, the information processing device 100 refers to the database storing the teaching data 61, searches for the grip force for the object to be gripped, and determines the grip force of the robot 10 (Step S52). Specifically, the information processing device 100 searches the database for the grip force (in the example of FIG. 8, the grip force “2N” at the time when the user has gripped the object “egg”) obtained in collection of the teaching data and inputs the result to the robot 10 to determine the grip force.

Note that, in a case where there is no teaching data in the database, the information processing device 100 may notify the user of the fact. In this case, the user applies ink to a finger and grips the object, and the ink trace is acquired. The information processing device 100 can immediately estimate an appropriate grip force by inputting the image including the ink trace to the model 70.

As described above with reference to FIGS. 2 to 8, the information processing device 100 acquires the grip force at the time when the user has gripped the object and the trace of gripping by the user that is left on the object at the time of gripping. Furthermore, in a case where an image including a trace of gripping a predetermined object by the user is input, the information processing device 100 generates the model 70 that outputs the grip force at a time when the predetermined object is gripped on the basis of the learning data obtained by combining the grip force and the trace that have been acquired. Then, when the robot 10 grips a desired object, the information processing device 100 can determine a grip force suitable for the robot 10 to grip the object by inputting, to the robot 10, a value estimated by the model 70 as the grip force at a time when the user grips the object.

As described above, according to the information processing device 100 according to the embodiment, it is possible to input an appropriate grip force to the robot 10 without using the tactile sensor 12 or the like. Moreover, the estimation of the grip force is implemented by such a simple method that the user applies ink and grips an object. Furthermore, at this point, the user can grip the object without wearing the tactile sensor 12, and thus the user can grip the object without changing the sense of the hand and fingers. As a result, the information processing device 100 can reduce the frequency of use of the tactile sensor 12 in inputting the grip force to the robot and can teach the robot 10 an appropriate grip force measured without changing the sense of the human hand and fingers.

### 1-4. Configuration of Information Processing Device According to Embodiment

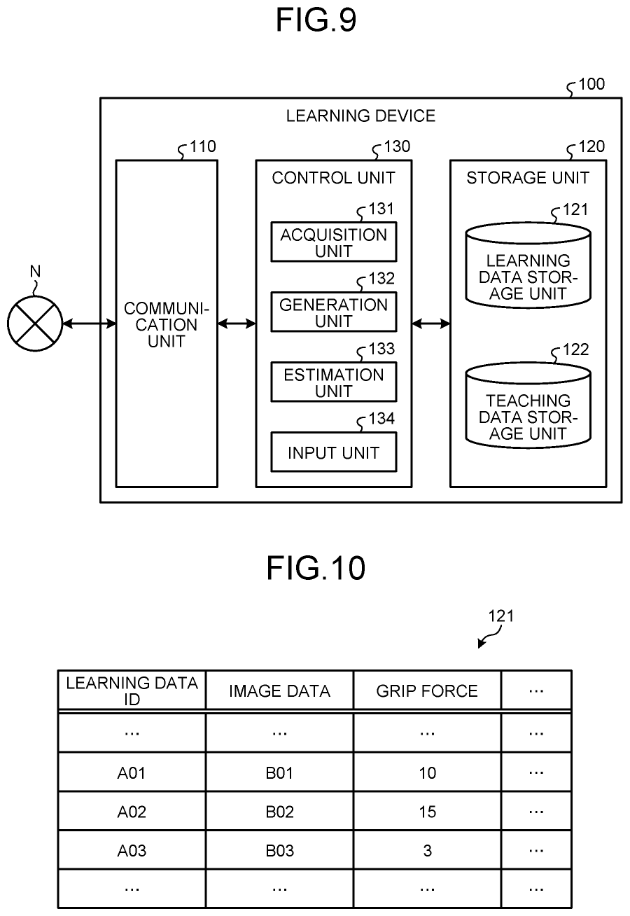

Next, a configuration of the information processing device 100 that executes information processing according to the embodiment will be described. FIG. 9 is a diagram illustrating a configuration example of the information processing device 100 according to the embodiment of the disclosure.

As illustrated in FIG. 9, the information processing device 100 includes a communication unit 110, a storage unit 120, and a control unit 130. Note that the information processing device 100 may include an input unit (such as a keyboard or a mouse) that receives various operations from a user or the like who manages the information processing device 100 or a display unit (such as a liquid crystal display) that displays various types of information.

The communication unit 110 is implemented by, for example, a network interface card (NIC), a network interface controller, or the like. The communication unit 110 is connected with the network N in a wired or wireless manner and transmits and receives information to and from the robot 10 and the like via the network N. The network N is implemented by, for example, a wireless communication standard or system such as Bluetooth (registered trademark), the Internet, Wi-Fi (registered trademark), ultra-wide band (UWB), low power wide area (LPWA), and ELTRES (registered trademark).

The storage unit 120 is implemented by, for example, a semiconductor memory element such as a random access memory (RAM) or a flash memory or a storage device such as a hard disk or an optical disk. The storage unit 120 includes a learning data storage unit 121 and a teaching data storage unit 122. Hereinafter, each of the storage units will be described in order.

The learning data storage unit 121 stores a learning data set used for model generation. The learning data storage unit 121 corresponds to, for example, the learning data set 60 illustrated in FIG. 3. Note that the learning data stored in the learning data storage unit 121 may be acquired from an external server or the like as appropriate without being held by the information processing device 100.

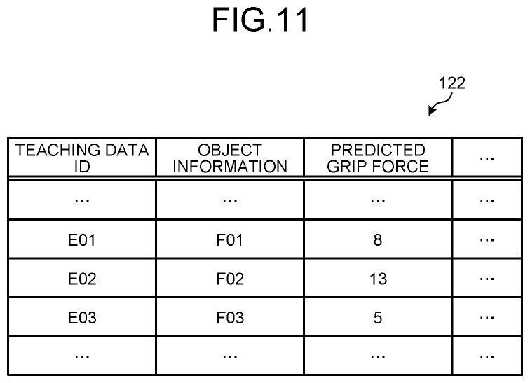

Illustrated in FIG. 10 is an example of the learning data storage unit 121 according to the embodiment. FIG. 10 is a table illustrating an example of the learning data storage unit 121 according to the embodiment of the disclosure. In the example illustrated in FIG. 10, the learning data storage unit 121 includes items such as “Learning Data ID”, “Image Data”, and “Grip Force”. Note that, in FIGS. 10 and 11, information held in each item may be indicated by a concept such as “B01”; however, in practice, specific information described below is stored in each item.

The “Learning Data ID” indicates identification information for identifying each piece of learning data. The “Image Data” indicates an image including a trace left on an object when the user has gripped the object. The “grip force” indicates an actual grip force measured by the tactile sensor 12 or the like when the user has gripped an object.

Next, the teaching data storage unit 122 will be described. The teaching data storage unit 122 stores information regarding an object to be gripped in association with a grip force estimated from a trace of gripping of the object by the user.

Illustrated in FIG. 11 is an example of the teaching data storage unit 122 according to the embodiment. FIG. 11 is a table illustrating an example of the teaching data storage unit 122 according to the embodiment of the disclosure. In the example illustrated in FIG. 11, the teaching data storage unit 122 includes items such as “Teaching Data ID”, “Object Information”, and “Grip Force”.

The “teaching Data ID” indicates identification information for identifying teaching data. The “object information” indicates various types of information for identifying an object. The object information is, for example, a label (ID information) that can identify an object such as the name of the object or an image capturing the object. The “Predicted Grip Force” indicates a grip force predicted by the model 70 on the basis of a trace.

Referring back to FIG. 9, the description will be continued. The control unit 130 is implemented by, for example, a central processing unit (CPU), a micro processing unit (MPU), or the like executing a program (for example, the grip force estimation program according to the disclosure) stored inside the information processing device 100 using a random access memory (RAM) or the like as a work area. The control unit 130 is also a controller and may be implemented by, for example, an integrated circuit such as an application specific integrated circuit (ASIC) or a field programmable gate array (FPGA).

As illustrated in FIG. 9, the control unit 130 includes an acquisition unit 131, a generation unit 132, an estimation unit 133, and an input unit 134 and implements or executes a function or an action of information processing described below. Note that the internal configuration of the control unit 130 is not limited to the configuration illustrated in FIG. 9 and may be another configuration as long as information processing described below is performed.

The acquisition unit 131 acquires various types of information. For example, the acquisition unit 131 acquires the grip force at a time when the user grips an object and a trace of gripping by the user left on the object at the time of gripping.

Specifically, the acquisition unit 131 acquires the grip force measured by the tactile sensor 12 or the like when the user has gripped the object and a fingerprint of the user left by the gripping. That is, the acquisition unit 131 acquires a fingerprint of the user left on the object when the user has gripped the object using fingers or the like to which ink has been applied in advance. More specifically, the acquisition unit 131 acquires the fingerprint of the user included in an image by acquiring the image obtained with the user photographing the fingerprint.

The acquisition unit 131 stores the acquired grip force and the fingerprint of the user in the storage unit 120 in association with each other.

In a case where an image including a trace of gripping a predetermined object by the user is input, the generation unit 132 generates the model 70 that outputs the grip force at a time when the predetermined object is gripped on the basis of the learning data obtained by combining the grip force and the trace that have been acquired by the acquisition unit 131.

Specifically, the generation unit 132 learns the learning data in which the grip force and the fingerprint of the user are combined by the learning model having a configuration such as the CNN, thereby generating the model 70 that receives a fingerprint as input and outputs a grip force.

The estimation unit 133 uses the model 70 generated by the generation unit 132 to estimate (predict) the grip force at a time when an object to be gripped is gripped from an image including a trace at a time when the user has gripped the object to be gripped.

The estimation unit 133 estimates the grip force at the time when the object to be gripped is gripped and further stores identification information for identifying the object to be gripped and the estimated grip force (predicted grip force) for the object to be gripped in the teaching data storage unit 122 in association with each other.

The input unit 134 inputs the grip force estimated by the estimation unit 133 to the robot 10 when the robot 10 attempts to grip the object to be gripped.

### 1-5. Application Examples of Embodiment

### 1-5-1. Fingerprint Complementing Processing

In order to implement more robust grip force estimation processing, the information processing device 100 according to the embodiment may further execute various types of processing described below.

As described above, in the grip force estimation processing according to the embodiment, the grip force is estimated using a fingerprint of the user left on an object. At this point, there is a possibility that only a partial fingerprint can be acquired such as that the fingerprint is blurred or partially missing. In this case, if prediction processing is performed using only the partial fingerprint, prediction performance by the NN may be degraded.

A method has been proposed in which a model is learned after preprocessing is performed in such a manner that an image in a learning data set also becomes partial (referred to as data augmentation or the like) in a case where it is based on the premise that such partial observation information (fingerprint in the example of the present disclosure) can be acquired at the time of inference in general. However, in such a method, it is difficult to set a parameter such as how much information is to be lost, and if the information is made to be lost too much, there is a possibility that the relationship between the image of the fingerprint and the grip force cannot be correctly learned.

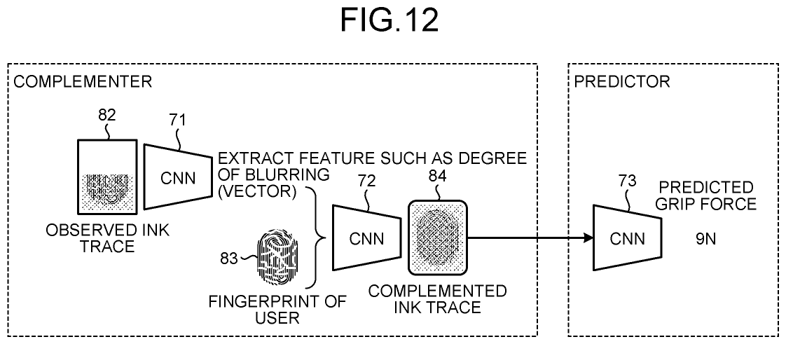

Therefore, in the present disclosure, a method of complementing partial information by image generation can be adopted by taking advantage of a characteristic that a fingerprint of a person basically does not change. For example, the information processing device 100 acquires the user's fingerprint in a complete state in advance and learns such features in the deep learning network, thereby making it is possible to restore the entire fingerprint by using only a part of the fingerprint at the time of inference. Specifically, the information processing device 100 generates a complementer that complements the fingerprint as a preceding stage of the model 73 for predicting the grip force. Such processing will be described with reference to FIG. 12 and subsequent drawings.

FIG. 12 is a diagram illustrating a configuration example of a model for executing fingerprint complementing processing. As illustrated in FIG. 12, in a case where the fingerprint complementing processing is executed, a complementer for complementing the fingerprint is disposed as the preceding stage of the model 73 (predictor) for estimating the grip force.

The complementer has a model 71 and a model 72 each having a CNN configuration. The model 71 receives, as input, a fingerprint 82 which is an ink trace actually observed and is not entirely clear but is only a partial trace. When the fingerprint 82 is input, the model 71 outputs a feature amount such as the degree of blurring as a vector.

The model 72 receives, as input, a fingerprint 83 that is a complete fingerprint of the user and the vector indicating the feature amount output from the model 71. Note that the user acquires the clear fingerprint 83 in advance, for example, by photographing the fingerprint using an object (paper or the like) on which an ink trace is likely to appear sharply. Then, the model 72 outputs a fingerprint generated from these features, that is, a restored fingerprint 84 that is an ink trace whose complete form has been restored (complemented) from the fingerprint 82.

Then, the information processing device 100 can predict the grip force at the time when the fingerprint 82 has been left by inputting the restored fingerprint 84 obtained from the complementer to the model 73.

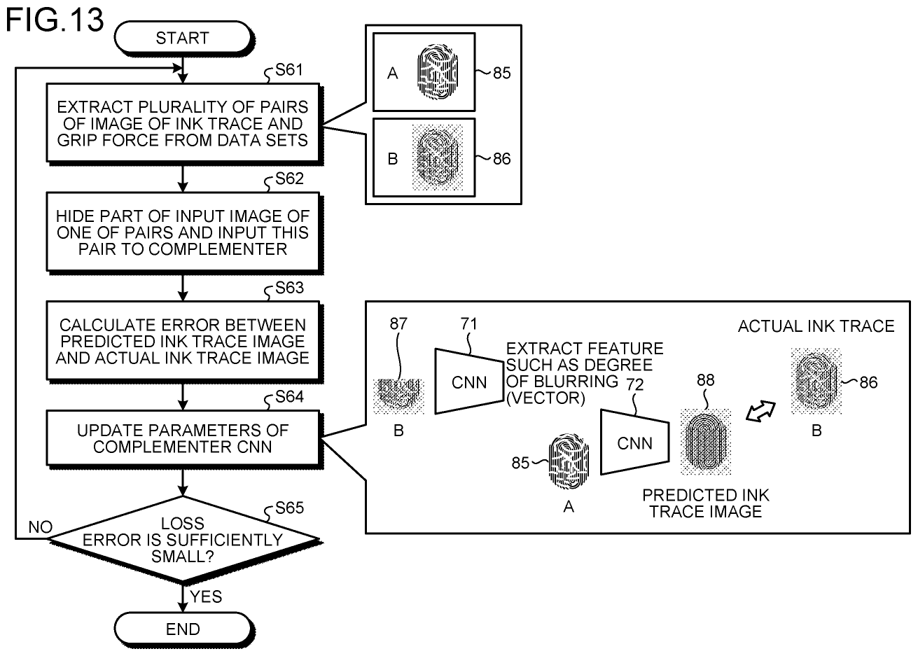

Next, a flow of learning processing of the complementer will be described with reference to FIG. 13. FIG. 13 is a flowchart illustrating the flow of the learning processing of the complementer regarding a fingerprint.

As illustrated in FIG. 13, the information processing device 100 extracts a plurality of pairs of an image of an ink trace and a grip force from the held data sets (for example, information stored in the learning data storage unit 121) (Step S61). Since the value of the grip force itself is not used in the learning of the complementer, illustration in FIG. 13 is omitted. In the example of FIG. 13, it is based on the premise that the information processing device 100 extracts a learning ink trace 85 and a learning ink trace 86. Note that it is based on the premise that this pair includes fingerprints acquired from the same user.

Subsequently, the information processing device 100 hides a part of an input image of one of the pairs and inputs the pair to the complementer (Step S62). In the example of FIG. 13, the information processing device 100 generates a learning ink trace 87 in which a part of the learning ink trace 86 is hidden and inputs the generated learning ink trace 87 to the complementer.

The learning ink trace 87 is input to the model 71 and output as a feature vector indicating a feature such as blurring. Then, the feature vector and the learning ink trace 85, which is paired with the learning ink trace 86, are input to the model 72 and output as a predicted ink trace image 88.

Then, the information processing device 100 compares the ink trace image 88 predicted by the complementer with the learning ink trace 86 which is the actual ink trace image and calculates an error thereof (Step S63).

The information processing device 100 updates parameters of the complementer CNN (namely, the model 71 and the model 72) so as to minimize such an error (Step S64).

The information processing device 100 determines whether or not a loss error related to the complementer is sufficiently small (Step S65). If the information processing device 100 determines that the loss error is not yet sufficiently small (Step S65; No), the processing from Step S61 to Step S64 is repeated, and the learning is continued. On the other hand, if it is determined that the loss error is sufficiently small (Step S65; Yes), the information processing device 100 completes generation of the model 71 and the model 72 of the complementer and acquires the complementer.

As described above, the information processing device 100 acquires the learning ink trace created by performing the processing of hiding a part of the fingerprint of the user.

Then, the information processing device 100 generates a complementing model for restoring the original fingerprint from a partially acquired fingerprint, the complementing model disposed as a preceding stage of the grip force prediction model, on the basis of the learning data in which the learning ink trace and the original fingerprint of the learning ink trace are combined.

As described above, even in a case where a fingerprint in which a part is missing is acquired in an actual measurement, the information processing device 100 can accurately estimate the grip force corresponding to the fingerprint by generating the complementer disposed as the preceding stage of the predictor.

Note that, in FIGS. 12 and 13, a configuration is adopted in which features such as the degree of blurring are first extracted as a vector by the model 71 from partial observation information and then the ink trace is restored from the vector and the image of the fingerprint 83 in the complete state. However, the configuration of the deep learning network is not limited to the above, and other configurations may be adopted.

Furthermore, in such processing, the pair extracted from the learning data set needs to be ones acquired from the same person; however, the entire data set does not need to be created from the same person.

### 1-5-2. Processing in Consideration of Surface Characteristics of Object

In order to implement more robust grip force estimation processing, the information processing device 100 according to the embodiment may further execute various types of processing described below.

As described above, in the grip force estimation processing according to the embodiment, the grip force is estimated using an ink trace of a fingerprint of the user left on an object. At this point, depending on the surface characteristics of the object on which the ink trace appears, the way how the ink trace appears may vary even with the same grip force. In the processing according to the above embodiment, since the input is an image of an ink trace, color characteristics and the like of the object surface are considered; however, it is conceivable that there are many objects having different surface characteristics even with the same color. If the appearance of the ink trace varies despite the same grip force, there is a possibility that the relationship between the image of the ink trace and the grip force cannot be correctly learned.

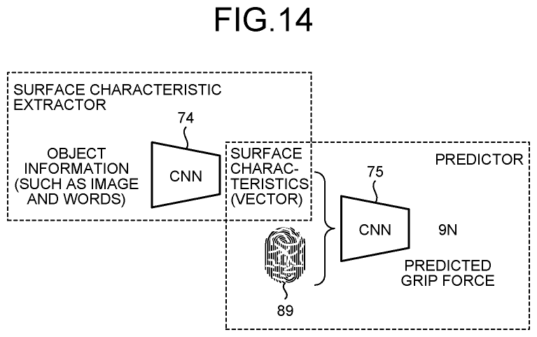

Therefore, the information processing device 100 can first extract the surface characteristics of the object and predict the grip force using the extracted characteristics. Such a surface characteristic extractor is disposed as a preceding stage of the predictor similarly to the aforementioned complementer. Such processing will be described with reference to FIG. 14 and subsequent drawings.

FIG. 14 is a diagram illustrating a configuration example of a model for executing extraction processing of surface characteristics of an object. As illustrated in FIG. 14, in a case where the processing of extracting the surface characteristic of the object is executed, the surface characteristic extractor is disposed as a preceding stage of the model 75 (predictor) for estimating the grip force.

The surface characteristic extractor has a model 74 having a CNN configuration. The model 74 receives information for identifying an object (linguistic information such as the name of the object and an image capturing the object) as input and outputs surface characteristics thereof as a feature vector.

Then, the information processing device 100 inputs the feature vector and a fingerprint 89 obtained from the surface characteristic extractor to the model 75, thereby predicting the grip force when the fingerprint 89 has been left on the object.

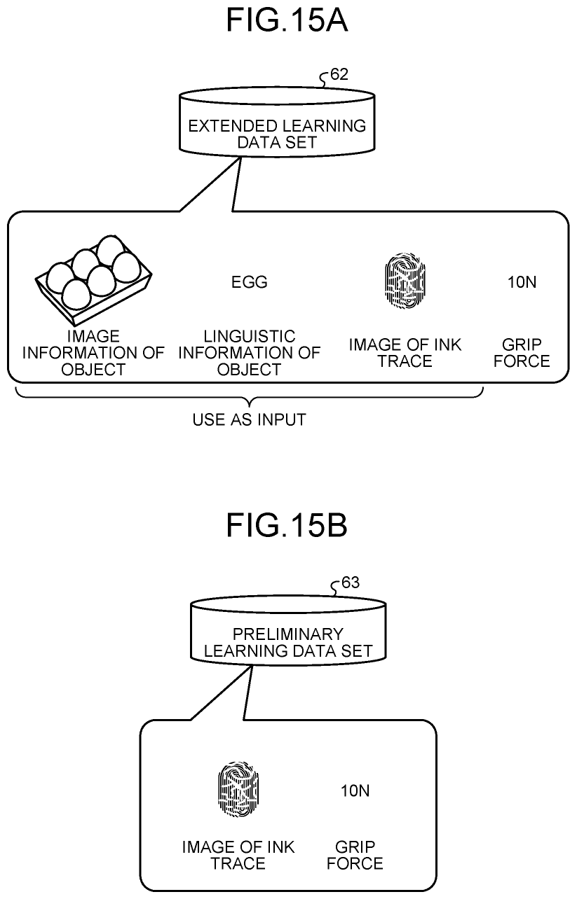

Next, the learning data used for learning of the surface characteristic extractor will be described with reference to FIGS. 15A and 15B. For learning of the surface characteristic extractor and the predictor, image information or linguistic information of the object are added in addition to the learning data set illustrated in FIG. 4A. FIG. 15A is a diagram for explaining an extended learning data set 62 for performing learning of the surface characteristic extractor.

As illustrated in FIG. 15A, in the extended learning data set 62, image information of an object, linguistic information of the object, an image of an ink trace obtained when the object is gripped, and the grip force obtained at the time of gripping are associated with each other. The information processing device 100 simultaneously learns parameters of the surface characteristic extractor and the predictor using the extended learning data set. In this case, all the parameters related to parameters of the surface characteristic extractor and the predictor are learned end-to-end.

Furthermore, in order to extract the surface characteristics with high accuracy, a method of pre-learning the surface characteristic extractor is also conceivable. FIG. 15B is a diagram for describing a preliminary learning data set 63. Data used in the preliminary learning is data in which images of ink traces with various grip forces appearing on an object are associated with the grip forces. If possible, such an image of an ink trace desirably includes an image of a clear and sharp ink trace appearing on an object such as paper.

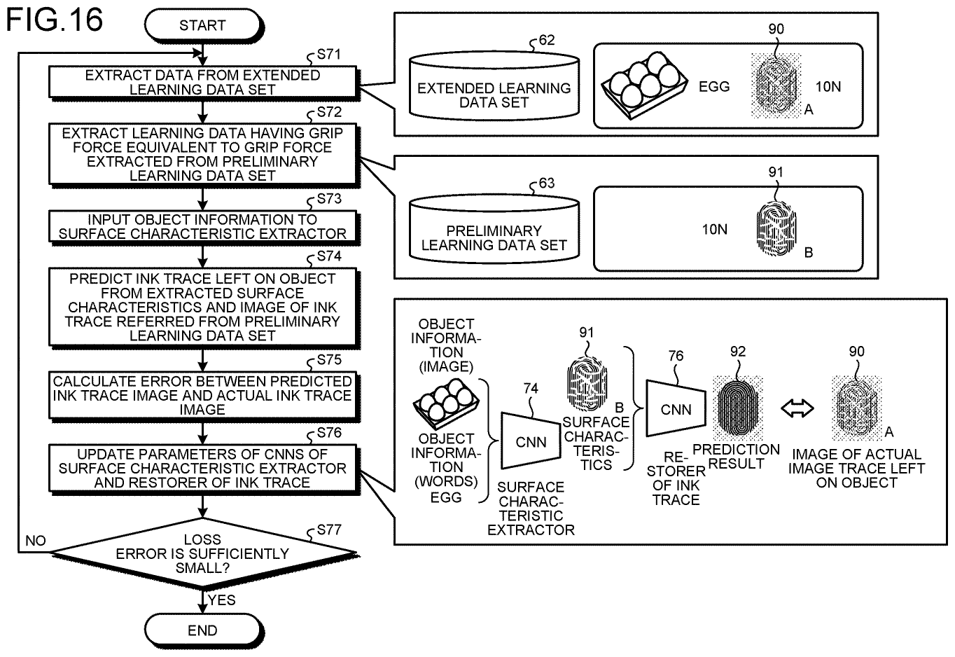

Next, a flow of learning processing of the surface characteristic extractor will be described with reference to FIG. 16. FIG. 16 is a flowchart illustrating a flow of learning processing of the surface characteristic extractor.

As illustrated in FIG. 16, the information processing device 100 first extracts a data set used for learning from the extended learning data set 62 (Step S71). In the example of FIG. 16, the information processing device 100 extracts a data set in which an object “egg”, an ink trace 90 at a time when the object has been gripped, and a grip force 10 N are associated with each other.

Subsequently, the information processing device 100 extracts, from the preliminary learning data set 63, learning data with which a grip force equivalent to the grip force in the learning data extracted in Step S71 is associated (Step S72). In the example of FIG. 16, the information processing device 100 extracts a data set in which an ink trace 91 showing a fingerprint relatively clearly and the grip force 10 N are associated with each other.

Subsequently, the information processing device 100 inputs object information (information for identifying an object) to the surface characteristic extractor (the model 74 illustrated in FIG. 16) and predicts surface characteristics (Step S73). Subsequently, the information processing device 100 inputs the extracted surface characteristics and the image of the clear ink trace 91 extracted from the preliminary learning data set 63 to a restorer (model 76) of an ink trace. That is, the model 76 predicts the image of the ink trace on the object and outputs an ink trace 92 which is the prediction result (Step S74).

Then, the information processing device 100 calculates an error between the ink trace 92 and the ink trace 90 which is an image of the actual ink trace on the object (Step S75).

The information processing device 100 updates parameters of the CNNs (in the example of FIG. 16, the model 74 and the model 76) of the surface characteristic extractor in such a manner that such an error is minimized (Step S76).

The information processing device 100 determines whether or not a loss error related to the surface characteristic extractor is sufficiently small (Step S77). If the information processing device 100 determines that the loss error is not yet sufficiently small (Step S77; No), the processing from Step S71 to Step S76 is repeated, and the learning is continued. On the other hand, if it is determined that the loss error is sufficiently small (Step S77; Yes), the information processing device 100 completes generation of the model 74 and the model 76 of the surface characteristic extractor and acquires the surface characteristic extractor.

By performing the preliminary learning as illustrated in FIG. 16, the surface characteristic extractor can extract useful features for changing the clear ink trace 91 to the ink trace 90 appearing on the actual object, namely, surface characteristics of each object. Note that although there is a restorer (model 76) at the time of the preliminary learning illustrated in FIG. 16, in a case where the surface characteristic extractor is used in the teaching step as illustrated in FIG. 6, the restorer is not used, and thus the restorer is present only at the time of the preliminary learning.

As described above, the information processing device 100 acquires the identification information for identifying the object and the image capturing the object together with the grip force and the trace at the time when the user has gripped the object. Furthermore, the information processing device 100 generates a surface characteristic extracting model (surface characteristic extractor) which is a model disposed as a preceding stage of the grip force prediction model, extracts surface characteristics of the object, and uses the trace, the identification information, and the image capturing the object as the learning data.

By using the surface characteristic extractor, the information processing device 100 can generate the predictor in consideration of features related to the surface characteristics. That is, since the information processing device 100 can predict different grip forces depending on the surface characteristics of an object even for similar fingerprints, it is possible to predict a more suitable grip force for each object.

### 1-5-3. Processing in Consideration of Unique Expression by User

When a person gives an instruction to grip an object, it is difficult to express by numerical values such as the grip force. Therefore, an instruction using language expression based on the user's own standards such as “hold gently” or “hold firmly” may be given. Since these instructions have different standards for each user (referred to as “user-specific information” or the like), it is generally difficult to teach such information to the robot 10. However, if the robot 10 exerts an appropriate grip force with the user giving these instructions to the robot 10, the user can control the robot 10 very easily.

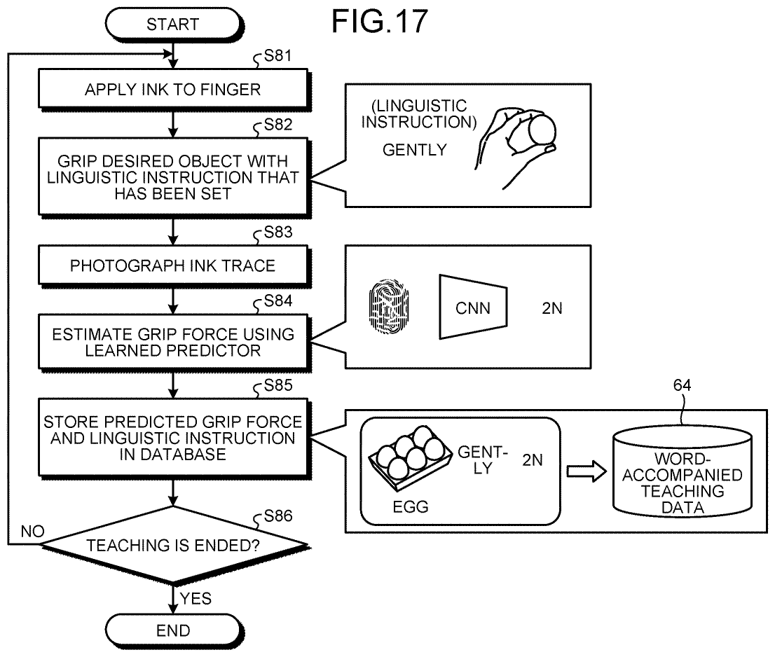

Therefore, the information processing device 100 may execute processing of controlling the grip force of the robot 10 on the basis of the user-specific instruction by learning the relationship between the user-specific instructions as described above and the grip force. This point will be described with reference to FIG. 17 and subsequent drawings.

FIG. 17 is a flowchart illustrating a flow of teaching processing in consideration of a linguistic instruction. Upon teaching, the user first applies ink to a finger (Step S81). Then, the user grips a desired object with a linguistic instruction set by the user as desired (Step S82).

For example, when a fragile object such as an egg is gripped, the user grips the object together with linguistic information such as “gently”. Then, the user photographs the ink trace left when the object has been gripped (Step S83).

The information processing device 100 estimates the grip force of the ink trace obtained in Step S83 using the predictor (for example, the model 70) generated in advance (Step S84).

Then, the information processing device 100 stores the predicted grip force and the linguistic instruction (“gently” in the example of FIG. 17) set by the user as desired in the database in association with each other (Step S85). Note that the information processing device 100 may store the linguistic instruction as text data input from the user or may store voice uttered by the user or data obtained by converting the voice into text.

As a result, the information processing device 100 can generate word-accompanied teaching data 64 in which the object information, the grip force, and the linguistic instruction (instruction such as “gently”) at the time of exerting the grip force are associated with each other.

Then, the information processing device 100 determines whether or not to end collecting the teaching data (Step S86). If collection of teaching data is continued (Step S86; No), the information processing device 100 repeats the processing from Step S81 to Step S85 and continues to collect teaching data of various objects. On the other hand, if it is determined that the user has finished collecting a necessary number of pieces of teaching data, the information processing device 100 ends collecting the teaching data (Step S86; Yes).

As described above, the information processing device 100 stores the estimated grip force for the object to be gripped, the identification information for identifying the object to be gripped, and the linguistic instruction of the user at the time of gripping in the storage unit 120 in association with each other. Furthermore, in a case where the robot 10 attempts to grip an object to be gripped, the information processing device 100 receives a linguistic instruction from the user and inputs, to the robot 10, the grip force stored in the storage unit 120 in association with the linguistic instruction.

In this manner, the information processing device 100 may store the linguistic instruction and the tactile information in association with each other. With the information processing device 100 teaching the robot 10 using such word-accompanied teaching data 64, when the user gives an instruction such as “hold the egg gently” to the robot 10, the robot 10 can determine an appropriate grip force in accordance with the instruction when gripping the egg. As a result, the user can instinctively teach the robot 10 an appropriate grip force by a linguistic instruction.

### 1-6. Modification of Embodiment

The above embodiments may include various different modifications. For example, in the above embodiment, the example in which the information processing device 100 of the grip force estimation system 1 learns the models has been described; however, the robot 10 itself may behave as an edge terminal by learning processing and learn the models.

Moreover, in the above embodiments, the example in which the information processing device 100 is a computer, a server, or the like has been described. However, the information processing device 100 is not limited to a smartphone, a tablet terminal, or the like and may be any device as long as it is a device capable of photographing an ink trace and the like and capable of executing the learning processing. For example, the information processing device 100 may be a digital camera or the like including an AI chip capable of executing the learning processing.

Furthermore, in the above embodiments, the example has been described in which the information processing device 100 acquires a fingerprint by ink as a trace left on an object. However, the trace is not limited to the fingerprint as long as the information represents the relationship with the grip force, and a trace of a palm left when an object is gripped, a trace of gripping an object by a user using a desired tool, or others may be used.

Furthermore, in the above-described embodiment, the example has been described in which the robot 10 is the robot arm having the so-called parallel two-finger gripper having the two gripping portions; however, the robot 10 is not limited thereto and may be a robot arm having multiple fingers or the like.

### 2. Other Embodiments

The processing according to the above embodiments may be performed in various different embodiments other than the above embodiments.

For example, among the processing described in the above embodiments, the whole or a part of the processing described as that performed automatically can be performed manually, or the whole or a part of the processing described as that performed manually can be performed automatically by a known method. In addition, a processing procedure, a specific name, and information including various types of data or parameters illustrated in the above or in the drawings can be modified as desired unless otherwise specified. For example, various types of information illustrated in the drawings are not limited to the information illustrated.

In addition, each component of each device illustrated in the drawings is conceptual in terms of function and is not necessarily physically configured as illustrated in the drawings. That is, the specific form of distribution or integration of each device is not limited to those illustrated in the drawings, and the whole or a part thereof can be functionally or physically distributed or integrated in any unit depending on various loads, usage status, and others.

In addition, the above embodiments and modifications can be combined as appropriate within a range where there is no conflict in the processing content.

Furthermore, the effects described herein are merely examples and are not limiting, and other effects may be achieved.

### 3. Effects of Grip Force Estimation Device According to Present Disclosure

As described above, the grip force estimation device (information processing device 100 in the embodiment) according to the present disclosure includes an acquisition unit (acquisition unit 131 in the embodiment) and a generation unit (generation unit 132 in the embodiment). The acquisition unit acquires the grip force at a time when a person grips an object and a trace of gripping by the person left on the object at the time of gripping. In a case where an image including a trace of gripping a predetermined object by the person is input, the generation unit generates the model that outputs the grip force at a time when the predetermined object is gripped on the basis of the learning data obtained by combining the grip force and the trace that have been acquired by the acquisition unit.

As described above, the grip force estimation device extends the method of using teaching by a person in determination of the grip force of the robot and generates a model in which the relationship between an image of a trace (ink trace or the like) and the grip force is learned in advance. As a result, the grip force estimation device can predict the grip force from a trace, and thus it is possible to reduce the use frequency of the tactile sensor and to teach the robot the grip force having been measured without changing the sense of a human hand and fingers.

The acquisition unit acquires the grip force at a time when a person grips an object and a fingerprint of the person left by the gripping. The generation unit generates the model on the basis of the learning data obtained by combining the grip force and the fingerprint.

As described above, the grip force estimation device can teach an appropriate grip force to the robot by using a fingerprint of a person without requiring a special instrument, a sensor, or the like.

In addition, the acquisition unit also acquires a learning fingerprint created by performing processing of hiding a part of the fingerprint of the person. The generation unit generates, on the basis of the learning data obtained by combining the learning fingerprint and the original fingerprint of the learning fingerprint, the complementing model for restoring the original fingerprint from a partially acquired fingerprint, the complementing model disposed as the preceding stage of the model.

As described above, the grip force estimation device can perform a more robust process of performing estimation by complementing even a partially missing fingerprint by using unchanged information such as a fingerprint.

Moreover, the acquisition unit acquires the identification information for identifying the object and the image capturing the object together with the grip force and the trace at the time when the person has gripped the object. The generation unit generates the surface characteristics extracting model which is a model disposed as the preceding stage of the model, extracts surface characteristics of the object, and uses the trace, the identification information, and the image capturing the object as the learning data.

As described above, the grip force estimation device can predict an appropriate grip force depending on the object more by generating the model in consideration of the surface characteristics of the object.

The grip force estimation device further includes an estimation unit (estimation unit 133 in the embodiment) that uses the model generated by the generation unit to estimate the grip force at a time when an object to be gripped is gripped from an image including a trace at a time when the person has gripped the object to be gripped.

As described above, since the grip force estimation device estimates the grip force using the model, it is possible to obtain an appropriate grip force without requiring a special instrument or preparation.

Furthermore, the estimation unit estimates the grip force at the time when the object to be gripped is gripped and stores identification information for identifying the object to be gripped and the estimated grip force for the object to be gripped in a storage unit (storage unit 120 in the embodiment) in association with each other.

As described above, the grip force estimation device can easily teach the robot by storing the teaching data in the storage unit.

The grip force estimation device further includes an input unit (input unit 134 in the embodiment) that inputs the grip force estimated by the estimation unit to the robot in a case where the robot attempts to grip an object to be gripped.

As described above, by inputting, to the robot, the grip force obtained on the basis of the trace of the person, the grip force estimation device can give the robot an appropriate grip force while omitting an extremely laborious work of determining the grip force while causing the robot to perform trial and error.

Furthermore, the estimation unit stores the estimated grip force for the object to be gripped, the identification information for identifying the object to be gripped, and the linguistic instruction of the user at the time of gripping in the storage unit in association with each other.

As described above, the grip force estimation device can generate a database obtained by collecting teaching data based on linguistic instructions by storing the grip force together with the linguistic instructions such as “hold gently”.

Furthermore, the grip force estimation device further includes the input unit that receives a linguistic instruction from the user in a case where the robot attempts to grip an object to be gripped and inputs, to the robot, the grip force stored in the storage unit in association with the linguistic instruction.

As described above, according to the grip force estimation device, the person who uses the robot can instinctively teach the robot an appropriate grip force by a linguistic instruction.

### 4. Hardware Configuration

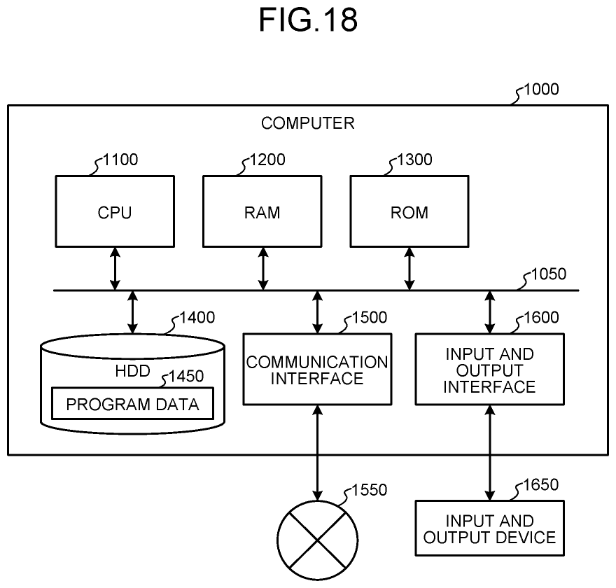

An information device such as the information processing device 100 or the robot 10 according to the embodiments described above is implemented by, for example, a computer 1000 having a configuration as illustrated in FIG. 18. Hereinafter, the information processing device 100 according to the embodiment will be described as an example. FIG. 18 is a hardware configuration diagram illustrating an example of the computer 1000 that implements the functions of the information processing device 100. The computer 1000 includes a CPU 1100, a RAM 1200, a read only memory (ROM) 1300, a hard disk drive (HDD) 1400, a communication interface 1500, and an input and output interface 1600. The components of the computer 1000 are connected by a bus 1050.

The CPU 1100 operates in accordance with a program stored in the ROM 1300 or the HDD 1400 and controls each of the components. For example, the CPU 1100 loads a program stored in the ROM 1300 or the HDD 1400 in the RAM 1200 and executes processing corresponding to various programs.

The ROM 1300 stores a boot program such as a basic input output system (BIOS) executed by the CPU 1100 when the computer 1000 is activated, a program dependent on the hardware of the computer 1000, and the like.

The HDD 1400 is a computer-readable recording medium that non-transiently records a program to be executed by the CPU 1100, data used by such a program, and the like. Specifically, the HDD 1400 is a recording medium that records the grip force estimation program according to the present disclosure, which is an example of program data 1450.

The communication interface 1500 is an interface for the computer 1000 to be connected with an external network 1550 (for example, the Internet). For example, the CPU 1100 receives data from another device or transmits data generated by the CPU 1100 to another device via the communication interface 1500.

The input and output interface 1600 is an interface for connecting an input and output device 1650 and the computer 1000. For example, the CPU 1100 receives data from an input device such as a keyboard or a mouse via the input and output interface 1600. The CPU 1100 also transmits data to an output device such as a display, a speaker, or a printer via the input and output interface 1600. Furthermore, the input and output interface 1600 may function as a media interface that reads a program or the like recorded in a predetermined recording medium. A medium refers to, for example, an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

For example, in a case where the computer 1000 functions as the information processing device 100 according to the embodiment, the CPU 1100 of the computer 1000 implements the function of the control unit 130 and others by executing the grip force estimation program loaded on the RAM 1200. The HDD 1400 also stores the grip force estimation program according to the present disclosure or data in the storage unit 120. Note that although the CPU 1100 reads the program data 1450 from the HDD 1400 and executes the program data 1450, as another example, these programs may be acquired from another device via the external network 1550.

Note that the present technology can also have the following configurations.
(1) A grip force estimation device comprising:
   an acquisition unit that acquires a grip force at a time when a person grips an object and a trace of gripping by the person, the trace left on the object at the time of the gripping; and
   a generation unit that generates a model that outputs a grip force at a time when a predetermined object is gripped in a case where an image is input, the image including a trace at a time when the predetermined object has been gripped by a person, on a basis of learning data obtained by combining the grip force and the trace acquired by the acquisition unit.
(2) The grip force estimation device according to (1),
   wherein the acquisition unit acquires the grip force at the time when the person grips the object and a fingerprint of the gripping by the person, and
   the generation unit generates the model on a basis of learning data obtained by combining the grip force and the fingerprint.
(3) The grip force estimation device according to (2),
   wherein the acquisition unit acquires a learning fingerprint created by performing processing of hiding a part of a fingerprint of the person; and
   the generation unit generates, on a basis of learning data obtained by combining the learning fingerprint and an original fingerprint of the learning fingerprint, a complementing model for restoring the original fingerprint from a partially acquired fingerprint, the complementing model disposed as a preceding stage of the model.
(4) The grip force estimation device according to any one of (1) to (3),
   wherein the acquisition unit acquires identification information for identifying the object and an image capturing the object together with the grip force at the time when the person grips the object and the trace, and
   the generation unit generates a surface characteristics extracting model for extracting a surface characteristic of the object by using the trace, the identification information, and the image capturing the object as learning data, the surface characteristics extracting model disposed as a preceding stage of the model.
(5) The grip force estimation device according to any one of (1) to (4), further comprising:
   an estimation unit that estimates a grip force at a time when an object to be gripped is gripped from an image including a trace at a time when a person grips the object to be gripped using the model generated by the generation unit.
(6) The grip force estimation device according to (5),
   wherein the estimation unit estimates the grip force at the time when the object to be gripped is gripped and stores, in a storage unit, identification information for identifying the object to be gripped and the estimated grip force for the object to be gripped in association with each other.
(7) The grip force estimation device according to (5) or (6), further comprising:
   an input unit that inputs the grip force estimated by the estimation unit to the robot when the robot attempts to grip the object to be gripped.
(8) The grip force estimation device according to any one of
   wherein the estimation unit stores, in a storage unit, the estimated grip force for the object to be gripped,
   identification information for identifying the object to be gripped, and a linguistic instruction by the user at the time of gripping in association with each other.
(9) The grip force estimation device according to (8), further comprising:
   an input unit that receives a linguistic instruction from the user and inputs a grip force stored in the storage unit in association with the linguistic instruction to the robot when the robot attempts to grip the object to be gripped.
(10) A grip force estimation method comprising:
   by a computer,
   acquiring a grip force at a time when a person grips an object and a trace of gripping by the person, the trace left on the object at the time of the gripping; and
   generating a model that outputs a grip force at a time when a predetermined object is gripped in a case where an image is input, the image including a trace at a time when the predetermined object has been gripped by a person, on a basis of learning data obtained by combining the grip force and the trace that have been acquired.
(11) A grip force estimation program for causing a computer to function as:
   an acquisition unit that acquires a grip force at a time when a person grips an object and a trace of gripping by the person, the trace left on the object at the time of the gripping; and
   a generation unit that generates a model that outputs a grip force at a time when a predetermined object is gripped in a case where an image is input, the image including a trace at a time when the predetermined object has been gripped by a person, on a basis of learning data obtained by combining the grip force and the trace acquired by the acquisition unit.

### REFERENCE SIGNS LIST

1 GRIP FORCE ESTIMATION SYSTEM
10 ROBOT
100 INFORMATION PROCESSING DEVICE
110 COMMUNICATION UNIT
120 STORAGE UNIT
121 LEARNING DATA STORAGE UNIT
122 TEACHING DATA STORAGE UNIT
130 CONTROL UNIT
131 ACQUISITION UNIT
132 GENERATION UNIT
133 ESTIMATION UNIT
134 INPUT UNIT

1. A grip force estimation device comprising:
an acquisition unit that acquires a grip force at a time when a person grips an object and a trace of gripping by the person, the trace left on the object at the time of the gripping; and
a generation unit that generates a model that outputs a grip force at a time when a predetermined object is gripped in a case where an image is input, the image including a trace at a time when the predetermined object has been gripped by a person, on a basis of learning data obtained by combining the grip force and the trace acquired by the acquisition unit.

2. The grip force estimation device according to claim 1,
wherein the acquisition unit acquires the grip force at the time when the person grips the object and a fingerprint of the gripping by the person, and
the generation unit generates the model on a basis of learning data obtained by combining the grip force and the fingerprint.

3. The grip force estimation device according to claim 2,
wherein the acquisition unit acquires a learning fingerprint created by performing processing of hiding a part of a fingerprint of the person; and
the generation unit generates, on a basis of learning data obtained by combining the learning fingerprint and an original fingerprint of the learning fingerprint, a complementing model for restoring the original fingerprint from a partially acquired fingerprint, the complementing model disposed as a preceding stage of the model.

4. The grip force estimation device according to claim 1,
wherein the acquisition unit acquires identification information for identifying the object and an image capturing the object together with the grip force at the time when the person grips the object and the trace, and
the generation unit generates a surface characteristics extracting model for extracting a surface characteristic of the object by using the trace, the identification information, and the image capturing the object as learning data, the surface characteristics extracting model disposed as a preceding stage of the model.

5. The grip force estimation device according to claim 1, further comprising:
an estimation unit that estimates a grip force at a time when an object to be gripped is gripped from an image including a trace at a time when a person grips the object to be gripped using the model generated by the generation unit.

6. The grip force estimation device according to claim 5,
wherein the estimation unit estimates the grip force at the time when the object to be gripped is gripped and stores, in a storage unit, identification information for identifying the object to be gripped and the estimated grip force for the object to be gripped in association with each other.

7. The grip force estimation device according to claim 5, further comprising:
an input unit that inputs the grip force estimated by the estimation unit to the robot when the robot attempts to grip the object to be gripped.

8. The grip force estimation device according to claim 5,
wherein the estimation unit stores, in a storage unit, the estimated grip force for the object to be gripped, identification information for identifying the object to be gripped, and a linguistic instruction by the user at the time of gripping in association with each other.

9. The grip force estimation device according to claim 8, further comprising:
an input unit that receives a linguistic instruction from the user and inputs a grip force stored in the storage unit in association with the linguistic instruction to the robot when the robot attempts to grip the object to be gripped.

10. A grip force estimation method comprising:
by a computer,
acquiring a grip force at a time when a person grips an object and a trace of gripping by the person, the trace left on the object at the time of the gripping; and
generating a model that outputs a grip force at a time when a predetermined object is gripped in a case where an image is input, the image including a trace at a time when the predetermined object has been gripped by a person, on a basis of learning data obtained by combining the grip force and the trace that have been acquired.

11. A grip force estimation program for causing a computer to function as:
an acquisition unit that acquires a grip force at a time when a person grips an object and a trace of gripping by the person, the trace left on the object at the time of the
a generation unit that generates a model that outputs a grip force at a time when a predetermined object is gripped in a case where an image is input, the image including a trace at a time when the predetermined object has been gripped by a person, on a basis of learning data obtained by combining the grip force and the trace acquired by the acquisition unit.
